(19) United States
(12) Patent Application Publication
(10) Pub. No.: US 2006/0084491 A1
(43) Pub. Date: Apr. 20, 2006

(54) Implementing wagering games using a pari-mutuel configuration

(76) Inventors: Fernando DiCarlo, Woodbridge (CA); Boris Karasik, Toronto (CA); Janir Asan, Woodbridge (CA)

Correspondence Address: MUSKIN & CUSICK LLC, 1800 CALLOWHILL ST, SUITE 200, PHILADELPHIA, PA, 19130, US

(21) Appl. No.: 10/977,360

(22) Filed: Oct. 29, 2004

Related U.S. Application Data
(63) Continuation-in-part of application No. 10/957,214, filed on Oct. 1, 2004.

(51) Int. Cl. A63F 13/00

(52) U.S. Cl. 463/19

(57) ABSTRACT

A method, apparatus, and computer readable storage to provide gaming machines that operate on a pari-mutuel basis. Prize levels can be determined based on bingo results, and the prize levels can be mapped to slot machine symbols such that the machines appear to play as a regular slot machine game.

### CROSS REFERENCE TO RELATED APPLICATIONS

This application is a Continuation in Part of application Ser. No. 10/957,214, filed on Oct. 1, 2004, which is incorporated herein by reference in its entirety.

### BACKGROUND OF THE INVENTION

1. Field of the Invention

The present invention is directed to a method, device, and computer readable storage medium for implementing wagering games using a pari-mutuel configuration. More particularly, the present invention allows winners playing wagering games such as bingo to be paid not on a fixed prize structure but paid a variable amount according to a pari-mutuel configuration.

2. Description of the Related Art

Wagering games such as bingo, keno, slot machines, etc., typically use a fixed award structure. That is, payouts and their respective triggers are posted ahead of time. When a player achieves a particular goal, such as getting a particular combination on a slot machine, the player wins a predetermined payout.

As opposed to fixed payouts, wagering games can also be based on a pari-mutuel configuration. A pari-mutuel configuration is one where bets placed are pooled, a house commission is removed from the pool, a game or event takes place, and the money remaining in the pool is distributed among winners. Horse racing is a common example of a pari-mutuel configuration.

In some jurisdictions, wagering games are legal only if they are based on a pari- mutuel configuration. However, traditional wagering games such as slot machines have always been implemented on a fixed payout basis.

Therefore, what is needed is a way to implement a variety of wagering games on a pari-mutuel basis.

### SUMMARY OF THE INVENTION

It is an aspect of the present invention to apply conventional wagering games to a pari-mutuel basis.

The above aspects can be obtained by a method that includes (a) receiving a variable first wager amount from a first player and a variable second wager amount from a second player; (b) pooling the first wager amount and the second wager amount into a pool amount; (c) completing a bingo game involving the first player and the second player; and (d) awarding the first player an award based on the pool amount and the first wager amount.

These together with other aspects and advantages which will be

subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating an exemplary server and associated slot machines, according to an embodiment;

FIG. 2 is a flowchart illustrating an exemplary method of accepting pari-mutuel wagers, according to an embodiment;

FIG. 3A is a flowchart illustrating an exemplary method of serving random numbers and processing awards, according to an embodiment;

FIG. 3B is a flowchart illustrating another exemplary method of serving numbers and processing awards, according to an embodiment;

FIG. 4 is a flowchart illustrating an exemplary method to award awards on a pari- mutuel basis, according to an embodiment;

FIG. 5 is a flowchart illustrating an exemplary method of determining awards on a pari-mutuel basis, according to an embodiment;

FIG. 6 is a diagram illustrating the apportionment of a bingo pool, according to an embodiment of the present invention;

FIG. 7 is a diagram illustrating how a pool is distributed, according to an embodiment; and

FIG. 8A is a block diagram illustrating a use of a robot player(s) at a slot machine, according to an embodiment;

FIG. 8B is a block diagram illustrating a use of a robot player(s) running at the server, according to an embodiment;

FIG. 9 is a chart illustrating a number of balls drawn during a simulation, according to an embodiment;

FIG. 10A is a flowchart illustrating a method of simulating and storing results of wagering results, according to an embodiment; and

FIG. 10B is a flowchart illustrating a method of implementing a non-pari mutuel variation of a wagering game, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present invention relates to implementing wagering games on a pari-mutuel basis. Slot machines (or other gaming devices) can have bingo cards associated with them which serve as the basis to determine winners and losers based on centrally generated random numbers.

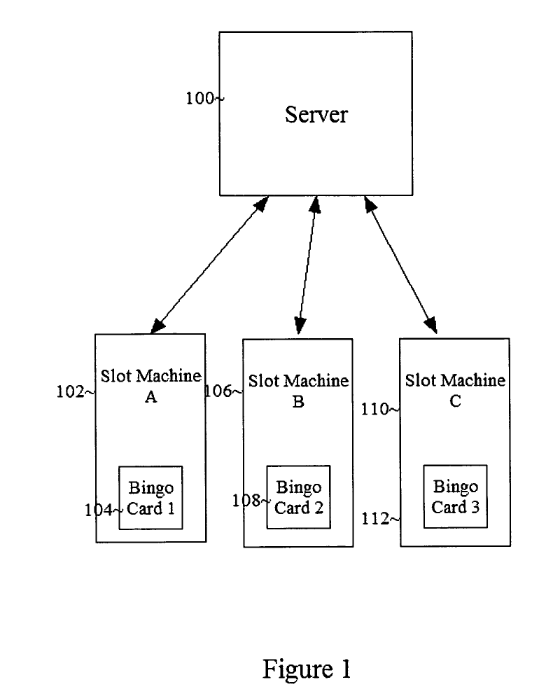

FIG. 1 is a block diagram illustrating an exemplary server and associated slot machines, according to an embodiment.

Central server 100 is used to perform central tasks such as generate random numbers, receive wagers from individual slot machines, tabulate winners, compute award amounts, and any other needed process. Server 100 is connected to slot machine A 102 which has bingo card 1 104 associated with it. Bingo card 1 104 can be served to slot machine A 102 by the central server 100. Similarly, server 100 is also connected to slot machine B which has bingo card 2 108 associated with it. Server 100 is also connected to slot machine C 110 which has bingo card 3 112 associated with it.

After each bingo (or game) round, the server 100 can serve the slot machines new bingo cards. The bingo cards can be pre-stored or generated randomly.

It is noted that in a pari-mutuel environment, prizes are generated from other wagers placed. Therefore, a temporal window exists in which players can place their wagers for a particular round. If a player fails to place a wager during the temporal window, then the player must wait until the next round to place a wager.

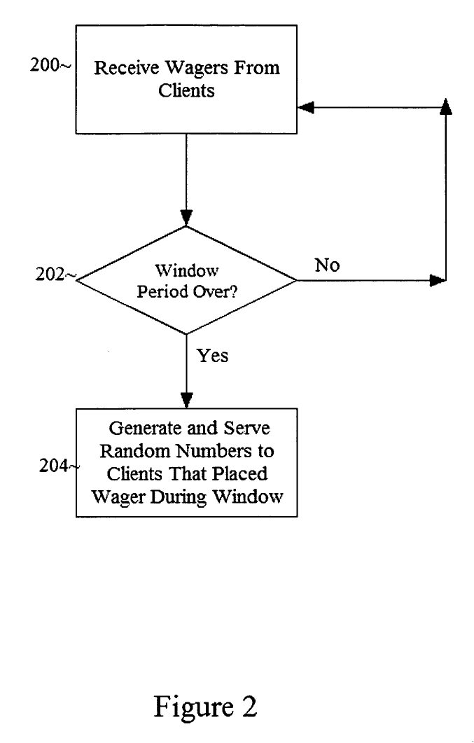

FIG. 2 is a flowchart illustrating an exemplary method of accepting pari-mutuel wagers, according to an embodiment.

The method begins with operation 200, which can receive wagers from clients (e.g. slot machines or other gaming devices). Wagers can be placed in any known fashion.

The method can then proceed to operation 202, which checks if the window period is over. A window period can be for example 5 seconds before a round starts. If the window period is not over, then the method returns to operation 200 which can receive further wagers from clients. If a player has already placed a wager, then the player typically waits until the window period is over.

Once the checking in operation 202 determines that the window period is over, then the method proceeds to operation 204 which generates and serves random numbers to clients that have placed wagers during the window period.

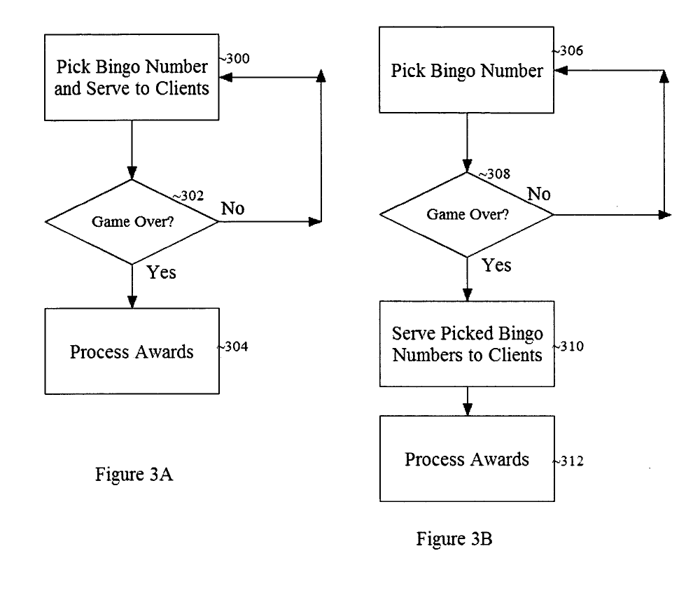

FIG. 3A is a flowchart illustrating an exemplary method of serving random numbers and processing awards, according to an embodiment.

The method starts with operation 300, which can pick a bingo number a serve to clients. The bingo number can be picked randomly by a computer, or can also be physically generated by a physical bingo machine.

The method then proceeds to operation 302, which checks if the game is over. If the game (or round) is not over, then the method returns to operation 300 which continues to pick numbers.

If the check in operation 302 determines that the game is over, then the method proceeds to operation 304, which processes the awards. The manner of processing the awards will be described below in more detail.

The method described previously continues to pick bingo numbers and serve them one by one until the game is over. Alternatively, an entire set of drawn bingo numbers can be generated and then served altogether.

FIG. 3B is a flowchart illustrating another exemplary method of serving numbers and processing awards, according to an embodiment.

The method begins in operation 306, which picks bingo numbers.

The method then proceeds to operation 308, which determines if the game is over. If the game is not over, then the method returns o operation 306.

If the checking in operation 308 determines that the game is over, then the method proceeds to operation 310, which serves the picked bingo numbers to client.

From operation 310, the method then proceeds to operation 312, which processes the awards.

Thus, the method illustrated in FIG. 3A serves bingo numbers as they are generated, while the method illustrated in FIG. 3B generates the entire set of numbers and then serves them. Either method can be used.

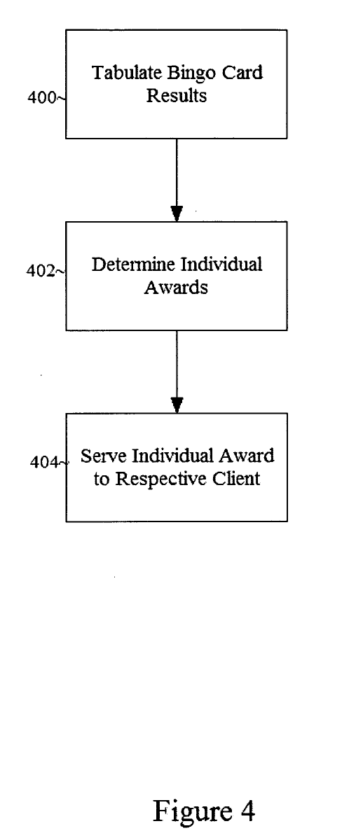

FIG. 4 is a flowchart illustrating an exemplary method to award awards on a pari- mutuel basis, according to an embodiment.

The central server 100 can be used to compute and award the awards.

The method begins in operation 400, which tabulates the bingo cards results. Each cards associated with each machine can be analyzed to see which card(s) have bingo, and which cards have how many spots picked (or any other characteristic of the cards as well).

From operation 400, the method proceeds to operation 402, which determines individual awards. This can be done using a method to be described below in more detail.

From operation 402, the method can proceed to operation 404, which serves each individual award to a respective client. The serving of the award can mean money (or other credits) are electronically transferred to the respective client.

Once the bingo round is over, the bingo cards for each machine need to be tabulated so that awards can be determined and disbursed. This can be performed on a pari-mutuel method as follows.

A plurality of discrete consolation prize levels can be defined for cards which do not get bingo but still should be entitled to a prize for covering a relatively large number of spots. The number of spots required for each prize level can be dependent upon a number of players in the overall bingo game. Table I is an example of a table defining a number of players in the game, a discrete consolation prize level, and the number of bingo spots needed to cover to qualify for that prize level. Of course, any other criteria and/or structure for defining prize levels can be used as well.

TABLE I

Prize #

| # Players | 6 | 5 | 4 | 3 | 2 | 1 |
|---|---|---|---|---|---|---|
| >150 | 7 | 8 | 9 | 10 | 11-12 | >12 |
| >70 | 8 | 9 | 10 | 11 | 12-13 | >13 |
| >40 | 9 | 10 | 11 | 12 | 13-14 | >14 |
| >18 | 10 | 11 | 12 | 13 | 14-15 | >15 |
| >10 | 11 | 12 | 13 | 14 | 15-16 | >16 |
| >6 | 12 | 13 | 14 | 15 | 16-17 | >17 |
| 4, 5, 6 | 13 | 14 | 15 | 16 | 17 | >17 |

Each consolation prize level can be assigned a weight. Table II is a table defining each prize number and a respective weight.

TABLE II

Prize #

| | 1 | 2 | 3 | 4 | 5 | 6 |
|---|---|---|---|---|---|---|
| Weight | 50 | 16 | 8 | 6 | 4 | 2.5 |

The total number cards that have bingo (designated as Nb) is determined. The sum of all bets for the Nb bingo cards that have bingo is then determined (designated as Bb).

The total pool of money wagered for a given round can be given by T. Wn can be considered the pool available for distribution after the house cut is removed, and can be computed by: Wn=T*h, wherein, h is the percentage of the total pool T that gets redistributed to the players. For example, h can be 95% (e.g. the house cut is 5%), or h can be any other feasible number. Local laws may provide a minimum value of h required.

The total number of cards that have a consolation prize is determined (designated as Nc). The average bet of cards with consolation prizes is determined (designated as Bc). This is determined by dividing the sum of bets for cards with consolation prizes by Nc.

The total amount won by bingo cards is determined (designated as Bw). This can be computed by factoring in any combination of factors such as Wn, Bb, Nb, Bc. One possible way to compute Bw is given by equation one:
Bw=(Wn*Bb*(a+Nb*b))/(Bb*(c+Nb*d)+Bc),
wherein a, b, c, and d are constants such that a=1.0, b=0.4, c=1.0, and d=0.4.

Of course a, b, c, and d are not limited to the above values and can be adjusted by the operator as desired to balance the distribution of payouts. Furthermore, other formulas besides equation one can be used to compute Bw. Formula one is just one mere example. Such a formula can take into consideration any combination or subset of Wn, Bb, Nb, and Bc (or other relevant values) in order to compute Bw (the amount won by bingo cards). Further, instead of computing Bw first, Cw can be computed similarly and Bw can then be derived from Cw (as discussed below in more detail).

Bw can be split between cards with bingo according to the bet. For example, if a particular bingo card has a bet of Bi, then the award for this card Ai can be computed by equation two:
Ai=Bi*Bw/Bb

The amount for consolation prizes (designated as Cw) can then be determined. This can be determined by the following equation three:
Cw=Wn−Bw

Every card with a consolation prize can be allocated a number of points (designated as Pci). Pci=Wi*Bi, wherein Wi is the weight of the prize (from Table II) and Bi is the bet for this card.

The total consolation points (designated as Pc) can be determined by summing all of the Pci for each card that has a consolation prize.

The prize for each card that has a consolation prize is designated by Cwi and can be found by equation four:
Cwi=Cw*Pci/Pc

Thus, the methods described above can start with a total pool of wagers T, determine the remaining pool to be distributed to the players Wn, determine the amount to be distributed to cards with bingo Bw, determine the amount to be distributed to cards with consolations prizes Cw, and then determine the individual awards for cards with bingo and for cards with consolation prizes. The distribution of prizes can be “fair” and equitable, which would consider how much individual players bet, the entire pool, and the prize level that that players have attained.

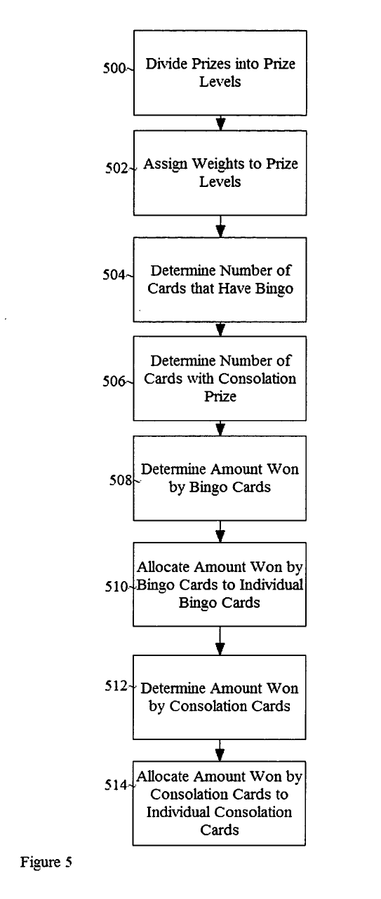

FIG. 5 is a flowchart illustrating an exemplary method of determining awards on a pari-mutuel basis, according to an embodiment.

The method begins in operation 500, which divides prizes into prize levels. This can be done as explained previously.

The method can continue to operation 502, which assigns weights to prize levels. This can be done as explained previously.

The method can continue to operation 504, which determines a number of cards that have bingo. This can be done by analyzing the current bingo cards to see which have spots covered in such a way that defines “bingo.”

The method can continue to operation 506, which determines a number cards with a consolation prize. This can be done by analyzing the current bingo cards to see which have spots covered in such a way to qualify for a consolation prize.

The method can continue to operation 508, which determines an amount won by the cards with bingo. This can be performed as described herein.

The method can continue to operation 510, which allocates amount won by bingo cards to individual bingo cards. This can be performed as described herein.

The method can continue to operation 512, which determines an amount won by consolation cards. This can be performed as described herein.

The method can continue to operation 514, which allocates an amount won by consolation cards to individual consolation cards. This can be performed as described herein.

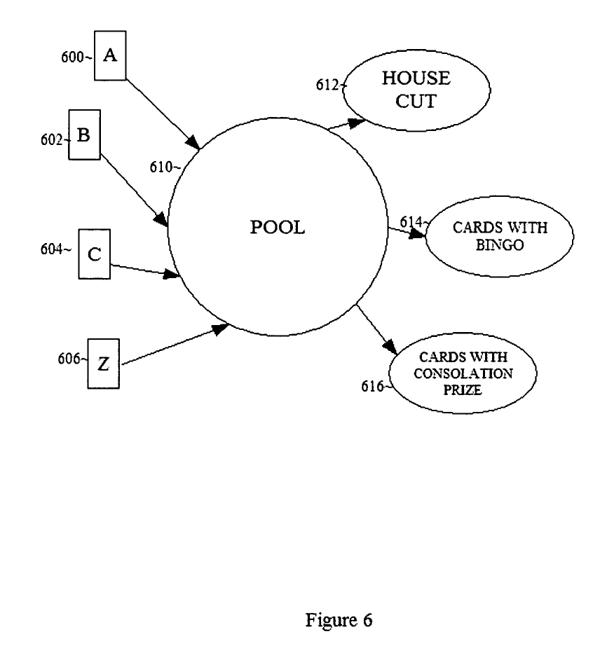

FIG. 6 is a diagram illustrating how a pool is distributed, according to an embodiment.

Slot machine A 600, B 602, C 604, and Z 606 all transmit their respective money wagered into a pool 610. The pool 610 is then split into a house cut pool 612, a cards with bingo pool 614, and a cards with a consolation prize pool 616. The house of course keeps the house cut 612, while the cards with bingo 614 pool is split between cards that have bingo and the cards with a consolation prize pool 616 is split between cards that have earned a consolation prize. The splitting of pools into their individual cards can be done using any of the methods described herein.

The methods and apparatuses described herein can be applied to slot machine games. For instance, prizes can be determined using the bingo methods described herein, and the results can then be “transferred” to a slot machine such that the slot machine displays reel symbols commensurate with the award earned. For example, if the above methods result in a player win of only a few coins, then an appropriate slot machine symbol combination may be “blank blank cherry.” If the player has won a lot of money on a round, then an appropriate slot machine symbol combination may be “7 7 7.” In this manner, players may feel like they are playing more of a typical slot machine and the fact that the awards are generated on a pari-mutuel basis can be transparent to the user.

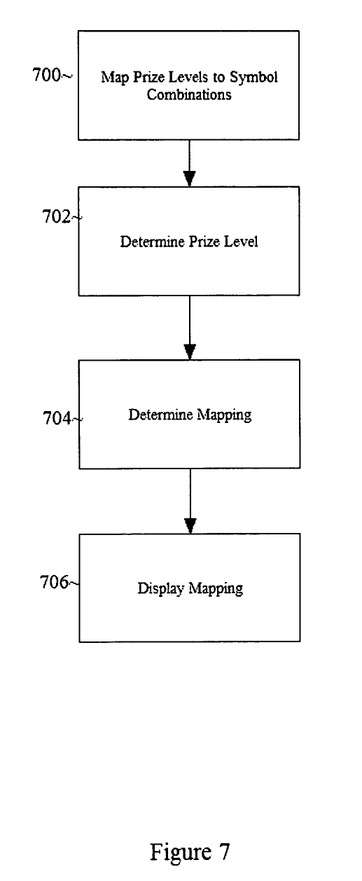

FIG. 7 is a flowchart illustrating an exemplary method of how a bingo prize can be mapped to slot machine play, according to an embodiment.

The method starts with operation 700, which maps prize levels to symbol combinations. An example such map appears below in Table III.

TABLE III

| Prize Level | Combination |
|---|---|
| Bingo | 7 7 7 |
| 1 | triple bar/triple bar/triple bar |
| 2 | double bar/double bar/double bar |
| 3 | single bar/single bar/single bar |
| 4 | cherry cherry cherry |
| 5 | any two cherries |
| 6 | any one cherry |

The method can then proceed to operation 702, which determines a prize level for an individual round. This can be done using any method such as those described herein.

The method can then proceed to operation 704, which determines mapping. The prize level determined in operation 702 is then mapped using a table (such as that illustrated in Table III) to determine a slot machine symbol combination.

The method can then proceed to operation 706, which displays the mapping determined in operation 704. The display can be performed using spinning symbols, etc., such that the machine emulates a traditional non-pari-mutuel slot machine.

Alternatively, symbol combinations can be determined based on a final award. For example, if a player has won 5 coins, a symbol combination can be associated with the win. Table IV illustrates an example of a table that maps award amounts to symbol combinations.

TABLE IV

| Award | Combination |
|---|---|
| >100 | 7 7 7 |
| 80-100 | triple bar/triple bar/triple bar |
| 60-79 | double bar/double bar/double bar |
| 50-78 | single bar/single bar/single bar |
| 40-49 | cherry cherry cherry |
| 1-39 | any two cherries |
| 0 | blank blank blank |

Thus, symbol combinations can be determined based on a prize level (e.g. Table III) or an amount won (e.g. Table IV).

In yet a further embodiment of the present invention, robot players can be used with human players. A robot player is a non-human player (e.g. software and/or hardware automated player) that can exist at any location, such as the central server, a remote server, or at an electronic gaming terminal itself. The robot player can place wagers from a separate pool or other source of funds, or can place wagers from any of the pools discussed herein.

One reason for using a robot player is that some jurisdictions require a minimum number of players in a pari-mutuel environment. A robot player may be able to satisfy this requirement. Another reason to use robot players is that a robot player(s) may be able to contribute large amounts of money/wagers to the pool(s). The larger the pools, the more closely a pari-mutuel wagering game can resemble in behavior and payout distribution a traditional wagering game such as a slot machine because there is more money to distribute to winning combinations.

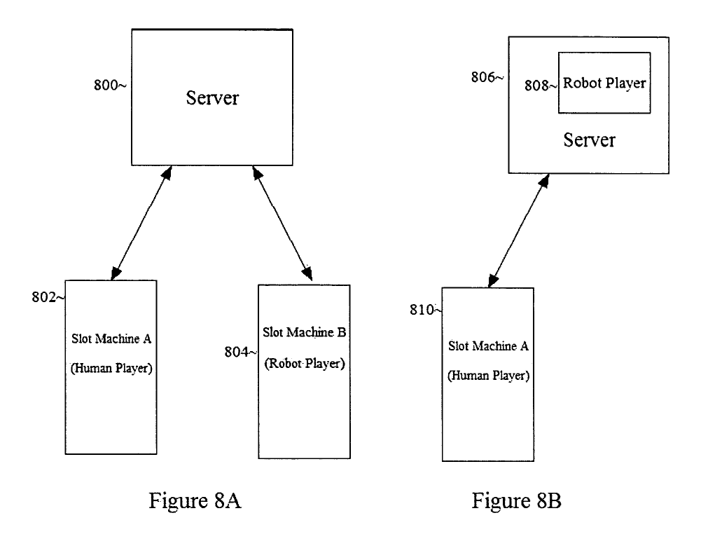

FIG. 8A is a block diagram illustrating a use of a robot player(s) at a slot machine, according to an embodiment. Note that in addition to slot machines as pictured, any other type of electronic gaming devices can be used.

A server 800 (as similar to server 100) is used to orchestrate the wagering game. A slot machine A 802 can be played by a human player, as described herein. A slot machine B 804 can be played by a robot player. The robot player can run software that contains a series of operations for playing the game. For example, the robot can place a predetermined (or random) wager and contribute to the pari-mutuel pool as a human would, play the wagering game, receiving any awards, and repeat the sequence. The sequence may include time delays or handshake signals from the server 800 (or other device in communication with the robot player) in order for the robot player to play. The robot player can maintain the robot's own source of money (either locally or remotely), or pool its money with other robots. Alternatively, the robot may also play from money already in any of the pari-mutuel pools. The robot player can be running directly on the slot machine B 804. Alternatively, the robot player can be running remotely (such as on server 800 or other remote server) to operate slot machine B 804.

FIG. 8B is a block diagram illustrating a use of a robot player(s) running at the server. Note that in addition to slot machines as pictured, any other type of electronic gaming devices can be used.

The server 806 (as similar to server 100) is used to orchestrate the wagering game. Server 806 interfaces with slot machine A 810 which can be operated by a human player. A robot player 808 can be running on the server 806. The robot player can run software that contains a series of operations for playing the game. For example, the robot can place a predetermined (or random) wager and can contribute to the pari-mutuel pool as a human would, play the wagering game, receiving any awards, and repeat the sequence. The sequence may include time delays or handshake signals from the server 800 (or other device in communication with the robot player) in order for the robot player to play. The robot player can maintain the robot's own source of money (either locally or remotely), or pool its money with other robots. Alternatively, the robot may also play from money already in any of the pari-mutuel pools. The robot player may also be running on a server separate from server 806 and in communication with server 806. In comparison to FIG. 8A, the robot illustrated in FIG. 8B does not require (or have to be associated with) a physical slot machine (or any other wagering device) to operate.

Thus, by using robot players, jurisdictional requirements may be satisfied which require a minimum number of players. Also, a robot player may contribute a large amount of money to the pool, allowing awards to human players to be distributed closer to traditional slot machine play. Also, a plurality of robot players can play which also add the benefits as described herein.

As described above, a temporal window can be used to determine the participants of a particular wagering game. Robot players can be used as preferred by the operators within the window as well. For example, if not enough players are playing within a particular window when it closes, then as many robot players that are needed to satisfy the requirements can be used. Alternatively, a human can place a wager at any electronic gaming device and a required number of robot players can be used with that player's wager, thus removing the need for using a temporal window. A robot or robots can also continuously place bets for each temporal window so that no window does not have enough players.

In another embodiment of the present invention, a non-pari-mutuel variation can be implemented. The non-pari-mutuel variation can simulate results from the pari-mutuel methods described herein. This method uses a bingo engine to generate awards but is not based on pari-mutuel pool, thus the house can lose money (at least in the short run).

The method first can run a simulation to determine and store a frequency of balls drawn during a bingo game. In a particular round, the number of balls drawn can vary, as balls can be drawn until a first party has bingo. During the simulation, the method can also store calculated awards (which can be calculated using the methods herein). When a player is actually playing this variation, the pre-stored data can be used to simulate the results of a pari-mutuel game, even though the player is not actually “competing” against anyone else.

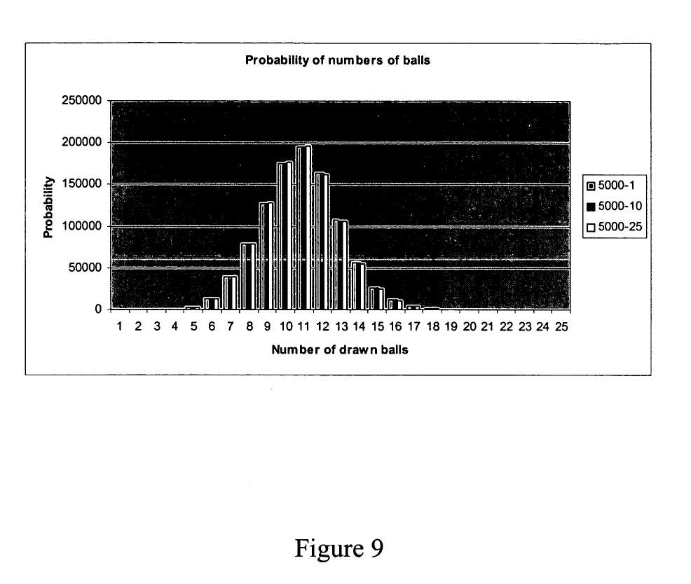

FIG. 9 is a chart illustrating a number of balls drawn during a simulation, according to an embodiment.

In FIG. 9, the x-axis represents a number of balls drawn, and a y-axis represents the number of times this number of balls has been drawn over 1,000,000 rounds. Thus, for example, 50,000 on the y-axis represents a probability of 5%. The three levels of bars represents a number of players in the group, e.g. 1, 10, and 25. Thus, it is most likely that 11 balls will be drawn, with a probability of almost 20%.

The balls drawn distribution illustrated in FIG. 9 can be used to simulate a pari- mutuel (or even non-pari-mutuel) version of bingo by allowing a server to draw a number of balls which simulates actual bingo games. For example, using the chart in FIG. 9, approximately 19% of the time 11 balls will be drawn, 17% of the time 12 balls will be drawn, etc.

It is noted that the number of players (or cards) in the simulation (or in real life) does not seem to affect the number of balls drawn, as long as the number of players in the group is relatively small (e.g. 25 and under). As the number of players approaches infinity, the number of balls drawn should decrease since it is easier for a player to achieve bingo (which can stop the pari-mutuel version of the game). In the non-pari- mutuel version of the game, groups of more than 25 players can be broken up into a plurality of groups of 25 (and any remainder).

In order to simulate the pari-mutuel version of the game, results should be determined so that they can be retrieved when a player plays the game.

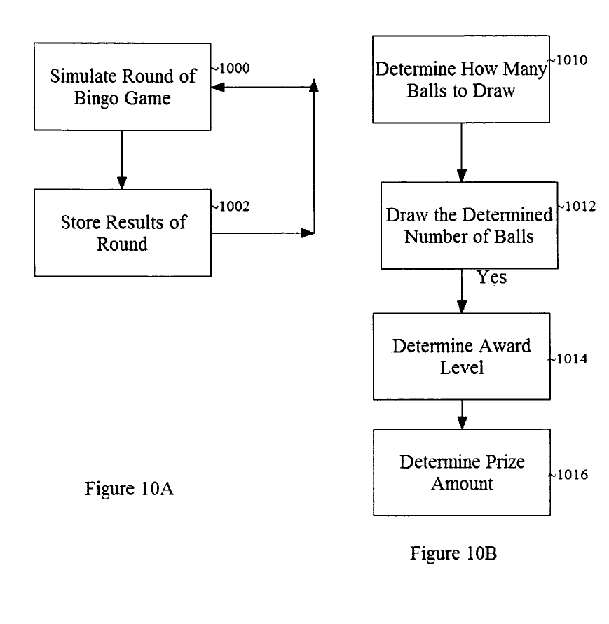

FIG. 10A is a flowchart illustrating a method of simulating and storing results of wagering results, according to an embodiment.

The method can start with operation 1000, which simulates a round of a bingo game. Any bingo rules can be used as selected by the designers. Typically, balls are drawn until a player has bingo (alternatively, balls can be drawn until n players have bingo or other stopping condition). The awards can be determined (as described herein).

The method can proceed to operation 1002, which stores the results of the round. The results of the round can comprise the number of balls drawn, the number of players with bingo, the distribution of the consolation prizes, the actual payouts computed for each of the prizes (e.g. bingo and each level of consolation prize), and any other relevant information. Note that the results of individual rounds need not each be stored, just the relevant data need be accounted for or accumulated.

The method can then return to operation 1000, which runs another round of the simulation. After a predetermined number of rounds are simulated (e.g. 1,000,000), the simulation can end (not pictured) and the results can be tabulated.

The data can be tabulated such as illustrated below in Table V or in Table VI.

TABLE V

| | | | | | | | |
|---|---|---|---|---|---|---|---|
| Match # | 5 | 6 | 7 | 8 | 9 | 10 | >10 |
| Prize ID | 7 | 6 | 5 | 4 | 3 | 2 | 1 |
| Weight | 1 | 2 | 4 | 10 | 25 | 50 | 250 |
| Bingo Weight | 500 | | | | | | |

TABLE VI

| | | | | | | | |
|---|---|---|---|---|---|---|---|
| Match # | 5 | 6 | 7 | 8 | 9 | 10 | >10 |
| Prize ID | 7 | 6 | 5 | 4 | 3 | 2 | 1 |
| Weight | 1 | 2 | 4 | 10 | 25 | 75 | 300 |
| Bingo Weight | 600 | | | | | | |

In Table V, a number of spots matched on a bingo card can determine a prize ID. A final win amount can be equal to the player's bet multiplied by the prize weight. If the player has five matching spots with form a bingo, the weight is 500, otherwise the weight is 1. A table such as illustrated in Table V can be generated using the simulation described in FIG. 10A and using any of the algorithms described herein (alone or in combination with algorithms known in the art). Table VI can be used similarly.

Once the results are known and stored for a pari-mutuel bingo game, it is not necessary to have players playing in a pari-mutuel version. Players can still play against the house (as a typical slot machine), although the results the player receives can be simulated to reflect a pari-mutuel version. Players can all be aggregated by the server or broken up into smaller groups (such as groups of 25 with a smaller group as the remainder).

FIG. 10B is a flowchart illustrating a method of implementing a non-pari mutuel variation of a wagering game, according to an embodiment.

The method begins in operation 1010, which determines how many balls to draw. This can be done as described above, by using the predetermined distribution of balls drawn (for example as illustrated in FIG. 9). This can be done for example by mapping each number of balls to a range of probabilities (e.g. from 0% to 100%) using the tabulated results from FIG. 10A, picking a random number from 1-100, identifying the range the number falls into, and drawing the number of balls that is mapped to that range. Thus, according to the distributions as illustrated in FIGS. 9, 5 and 18 balls will be drawn relatively infrequently, while 11 balls will be drawn the most frequently.

The method can then proceed to operation 1012, which draws the determined number of balls. The bingo cards possessed by the players are then judged to determine which, if any, players have bingo or other consolations prizes. It is possible that no players have bingo since the number of balls are predetermined as described above.

From operation 1012, the method proceeds to operation 1014, which determines the award level for the players that have earned a bingo or a consolation prize. This can be done by determining whether the player has bingo or counting how many spots the player has matched which can earn him a consolation prize level (this corresponds to a prize ID in Table V).

From operation 1014, the method proceeds to operation 1016, which can determine the prize amount. This can be accomplished by using a table such as Table V, by looking up an award based on a current prize ID.

In the manner described with respect to FIGS. 10A and 10B, a bingo game can be simulated to a player or players even though the player is playing against the house and not on a pari-mutuel basis. It may be transparent to the player that he or she is not really playing a pari-mutuel based game. While the house may lose money in the short run using this embodiment, of course since the computed payouts were determined factoring a house advantage, in the long run the house will profit.

The present invention has been described with respect to implementing slot machine games on a pari-mutuel basis or on a simulated pari-mutuel basis. This can be important in jurisdictions where certain types or wagering are legal or illegal.

It is also noted that any type of gaming machine can implement the present invention, whether the gaming machine is video or mechanical, random environment, class III or any other class, local software or downloadable client, or any other software/hardware implementations of gaming/machines currently known in the art.

It is further noted that the for the purposes herein, betting “coins” or “credits” are typically interchangeable, and that a “wager amount” can refer to coins, credits, currency, etc. Credits typically exist locally on a particular machine, although credits can also exist remotely (e.g. on a server) and can be depleted by a player by playing a machine.

Furthermore, it is noted that any of the operations of the methods described herein can be performed in any sensible order. Individual operations may be optional or may be combined with other operations. The invention is not limited to the particular order of operations described and illustrated herein.

It is also noted that any and/or all of the above embodiments, configurations, variations of the present invention described above can mixed and matched and used in any combination with one another. Any claim herein can be combined with any others (unless the results are nonsensical). Further, any mathematical formula given above also includes its mathematical equivalents, and also variations thereof such as multiplying any of the individual terms of a formula by a constant(s) or other variable.

Moreover, any description of a component or embodiment herein also includes hardware, software, and configurations which already exist in the prior art and may be necessary to the operation of such component(s) or embodiment(s).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of implementing a wagering game on a pari-mutuel basis, the method comprising:
receiving a variable first wager amount from a first player and a variable second wager amount from a second player;
pooling the first wager amount and the second wager amount into a pool amount;
completing a bingo game involving the first player and the second player; and
awarding the first player an award based on the pool amount and the first wager amount.

2. A method as recited in claim 1, further comprising receiving variable wager amounts from n players;

3. A method as recited in claim 1, wherein a higher the first wager amount, a higher the award.

4. A method as recited in claim 1, wherein the award is proportional to the first player's contribution to the pool amount and the first wager amount.

5. A method as recited in claim 1, further comprising:
mapping an award amount to the first player to a symbol combination; and
displaying the symbol combination on a gaming device used by the first player.

6. A method as recited in claim 1, wherein the second player is a robot player.

7. A method as recited in claim 1, wherein the robot player is running on a server.

8. A method as recited in claim 1, wherein the robot player is running on a separate gaming terminal.

9. A method of implementing a wagering game on a pari-mutuel basis, the method comprising:
defining a plurality of prize levels;
defining a plurality of required covered bingo spots to earn a respective prize level;
completing a bingo game; and
determining a prize level of an award in a bingo game for a first player based on a number of covered bingo spots for a bingo card of the first player.

10. A method as recited in claim 9, further comprising:
defining a plurality of ranges of players

11. A method as recited in claim 9, further comprising determining an award amount for the first player using the prize level.

12. A method as recited in claim 9, further comprising determining an award amount for the first player using the prize level and using a wager amount by the first player.

13. A method as recited in claim 12, wherein a higher the wager amount, a high the award amount is.

14. A method as recited in claim 9, further comprising:
pooling wagers from players partaking in the bingo game into a pool; and
dividing the pool into a bingo component amount for players that receive bingo and a consolation prize component amount for players that do not receive bingo but receive a consolation prize.

15. A method as recited in claim 14, further comprising:
if the first player has bingo, determining an award amount for the first player by using the bingo component amount and a wager amount by the first player.

16. A method as recited in claim 15, wherein the award amount is computed as the wager amount by the first player*the bingo component amount/a total amount wagered by players that receive bingo.

17. A method as recited in claim 14, further comprising:
if the first player does not have bingo but is to receive a consolation prize, determining an award amount for the first player by using the consolation prize component amount and a wager amount by the first player.

18. A method as recited in claim 17, wherein the award amount is computed as the wager amount by the first player*the consolation prize component amount/a total amount wagered by players that receive a consolation prize.

19. A method of implementing a wagering game on a pari-mutel basis, the method comprising:
pooling wagers from players in a bingo game into a pool;
completing the bingo game; and
dividing the pool into a bingo component amount and a consolation prize component amount.

20. A method as recited in claim 19, further comprising:
splitting the bingo component amount among players that receive bingo in the bingo game.

21. A method as recited in claim 20, wherein there is a direct relationship between a particular player's award from the bingo component amount and a wager amount by the particular player.

22. A method as recited in claim 19, further comprising:
splitting the consolation prize component amount among players that do not receive bingo but quality for a consolation prize in the bingo game.

23. A method as recited in claim 22, wherein there is a direct relationship between a particular player's award from the consolation prize component amount and a wager amount by the particular player.

24. A method as recited in claim 22, further comprising:
splitting the bingo component amount among players that receive bingo in the bingo game.

25. A method of implementing a wagering game on a pari-mutel basis, the method comprising:
generating a prize level on a pari-mutuel basis;
mapping the award to a symbol combination; and
displaying the symbol combination.

26. A method as recited in claim 25, wherein a prize level corresponds to a number of bingo spots matched on a bingo card.

27. A method as recited in claim 25, wherein a prize level corresponds to a characteristic of a bingo card.

28. A method of implementing a wagering game on a pari-mutel basis, the method comprising:
generating an award on a pari-mutuel basis;
mapping the award to a symbol combination; and
displaying the symbol combination.

29. A method of implementing a wagering game, the method comprising:
receiving a first wager amount from a player that contributes to a pari-mutuel pool amount;
receiving a second wager amount from a robot player that contributes to the pari- mutuel pool amount; and
completing the wagering game and accounting for the first wager and the second wager using the pool amount.

30. A method as recited in claim 29, wherein the robot player is running on a server.

31. A method as recited in claim 29, wherein the robot player is running on a separate gaming terminal.

32. A method as recited in claim 29, wherein an award to the first player is computed based on the first wager amount and the pool amount.

33. A method as recited in claim 29, wherein a temporal window is presented before accepting the first wager amount from the player.

34. A method as recited in claim 29, wherein the first wager amount is accepted instantly from the player.

35. A method of implementing a wagering game, the method comprising:
storing a plurality of number of balls drawn for a bingo game and a respective probability of drawing a respective number of balls; and
implementing a bingo round by choosing to draw a particular number of balls with a frequency of a respective probability of drawing the particular number of balls in a real bingo round.

36. A method as recited in claim 35, further comprising:
determining a number of matches on a bingo card; and
determining a prize ID from the number of matches.

37. A method of implementing a wagering game, the method comprising:
drawing a non constant and predetermined number of bingo balls for a plurality of players; and
using the bingo balls to implement a bingo based round.

38. A method as recited in claim 37, wherein the predetermined number of balls drawn in the bingo round is derived from a simulated distribution.

39. A method as recited in claim 38, wherein the number of balls drawn is predetermined and determined based on an actual frequency of drawing the number of balls drawn in an actual bingo round.

40. An apparatus to implement wagering game on a pari-mutuel basis, the method comprising:
a receiving unit receiving a variable first wager amount from a first player and a variable second wager amount from a second player;
a pooling unit pooling the first wager amount and the second wager amount into a pool amount;
a completing unit completing a bingo game involving the first player and the second player; and
an awarding unit awarding the first player an award based on the pool amount and the first wager amount.

41. A computer readable storage medium storing a method of implementing a wagering game on a pari-mutuel basis, the medium controlling a computer by:
receiving a variable first wager amount from a first player and a variable second wager amount from a second player;
pooling the first wager amount and the second wager amount into a pool amount;
completing a bingo game involving the first player and the second player; and
awarding the first player an award based on the pool amount and the first wager amount.
